(19) United States
(12) Patent Application Publication
(10) Pub. No.: US 2023/0335968 A1
(43) Pub. Date: Oct. 19, 2023

(54) PASSIVELY MODE-COUPLED FIBER OSCILLATOR AND LASER DEVICE HAVING SUCH A FIBER OSCILLATOR

(71) Applicant: TRUMPF Laser GmbH, Schramberg (DE)

(72) Inventors: Florian Graf, Aichhalden (DE); Aleksander Budnicki, Waldkirch (DE)

(21) Appl. No.: 18/337,053

(22) Filed: Jun. 19, 2023

Related U.S. Application Data
(63) Continuation of application No. PCT/EP2021/084576, filed on Dec. 7, 2021.

(30) Foreign Application Priority Data
Dec. 21, 2020 (DE) 10 2020 216 433.9

(51) Int. Cl. H01S 3/067; H01S 3/08

(52) U.S. Cl. CPC H01S 3/06791; H01S 3/0675; H01S 3/08013

(57) ABSTRACT

A passively mode-coupled fiber oscillator includes a bidirectional loop, a unidirectional loop, and a 3×3 coupler. The bidirectional loop and the unidirectional loop are coupled to each other by the 3×3 coupler. The bidirectional loop includes a first amplifying fiber. The fiber oscillator has overall a normal dispersion.

### CROSS REFERENCE TO RELATED APPLICATIONS

This application is a continuation of International Application No. PCT/EP2021/084576 (WO 2022/135910 A1), filed on Dec. 7, 2021, and claims benefit to German Patent Application No. DE 10 2020 216 433.9, filed on Dec. 21, 2020. The aforementioned applications are hereby incorporated by reference herein.

### FIELD

Embodiments of the present invention relate to a passively mode-coupled fiber oscillator and to a laser device that includes a pump light source and such a fiber oscillator.

### BACKGROUND

Passively mode-coupled fiber oscillators often have a saturable absorber, in particular a semiconductor saturable absorber mirror, abbreviated to SESAM. Such a SESAM is, however, susceptible to degradation and deadjustment. For this reason, it has proven difficult to provide such a mode-coupled fiber oscillator reproducibly in the wavelength ranges from about 900 nm to about 2100 nm for longterm-stable operation in an industrial environment. Yet it is these wavelength ranges that are of interest for material processing and the telecommunications sector, on the one hand, and the medical technology sector and semiconductor processing on the other hand. Providing such a fiber oscillator having well-defined dispersion properties has furthermore proven challenging.

### SUMMARY

Embodiments of the present invention provide a passively mode-coupled fiber oscillator. The fiber oscillator includes a bidirectional loop, a unidirectional loop, and a 3×3 coupler. The bidirectional loop and the unidirectional loop are coupled to each other by the 3×3 coupler. The bidirectional loop includes a first amplifying fiber. The fiber oscillator has overall a normal dispersion.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a first exemplary embodiment of a passively mode-coupled fiber oscillator;

FIG. 2 shows a schematic representation of a second exemplary embodiment of a passively mode-coupled fiber oscillator;

FIG. 3 shows a schematic representation of a third exemplary embodiment of a passively mode-coupled fiber oscillator;

FIG. 4 shows a diagrammatic explanation of the functionality of a bandwidth-limiting element in a fiber oscillator according to some embodiments, and

FIG. 5 shows a schematic representation of a fourth exemplary embodiment of a passively mode-coupled fiber oscillator.

### DETAILED DESCRIPTION

Embodiments of the present invention provide a passively mode-coupled fiber oscillator and a laser device having such a fiber oscillator, without the aforementioned disadvantages occurring.

Embodiments of the present invention provide a passively mode-coupled fiber oscillator having a bidirectional loop and a unidirectional loop. The bidirectional loop and the unidirectional loop are coupled to one another by a 3×3 coupler. The bidirectional loop comprises a first amplifying fiber, and the fiber oscillator has overall a normal dispersion. Advantageously, the bidirectional loop may fulfill the function of a saturable absorber, so that the fiber oscillator may in particular obviate a SESAM. The problem of degradation and deadjustment associated with a SESAM is therefore also entirely avoided. In particular, no problems with degradation and/or deadjustment occur in connection with the bidirectional loop. By suitable selection of the first amplifying fiber, in particular of an element with which the first amplifying fiber is doped, suitable wavelengths may be provided for the fiber oscillator, e.g., in the range of from about 900 nm to 1100 nm (ytterbium, neodymium) through 1500 nm (erbium) to from about 1900 nm to 2100 nm (thulium, holmium). By specific tuning of the overall dispersion of the fiber oscillator in the normal range, well-defined dispersion properties are advantageously provided. In particular, no strict limitation of the pulse energy due to the soliton theorem arises in the normal dispersion range, so that there is greater flexibility in respect of the pulse energy than in the anomalous dispersion range. Furthermore, the problem of energy being coupled out onto Kelly sidebands does not arise in the normal dispersion range, and undesired spectral components associated therewith are advantageously avoided.

When using ytterbium or neodymium as a doping element, the dispersion advantageously already lies in the normal range. Even so, a dispersion-compensating element may also be used when using these doping elements, in order to shift the dispersion into a desired range, in particular for fine tuning of the dispersion. When using erbium, thulium or holmium as a doping element, a dispersion-compensating element may advantageously be used in order to shift the dispersion into the normal dispersion range.

The fiber oscillator allows, in particular, reproducible, longterm-stable operation in an industrial environment in the aforementioned wavelength ranges.

A fiber oscillator is intended in particular to mean a laser oscillator that comprises at least one optical component, in particular for guiding light and/or influencing light, which comprises a fiber or consists of a fiber. In a preferred configuration, it is possible for all optical components of the fiber oscillator to be fiber components, that is to say components which in particular comprise a fiber or consist of a fiber, in particular fiber-based components or fiber-coupled components.

A loop is intended to mean an optical part of the fiber oscillator, which has a first end and a second end, both the first end and the second end being coupled to the same terminal component of the fiber oscillator, here in particular to the 3×3 coupler. This means in particular that light pulses that have traveled through the loop starting from the terminal component travel back again along the loop to the terminal component. Such a loop may be configured overall as a ring; in particular, the loop in this case consists of a ring part. It is, however, also possible for such a loop to comprise at least one ring part and at least one linear branch connected to the ring part so as to conduct light, in particular precisely one ring part and precisely one linear branch.

A bidirectional loop is intended in particular to mean a loop in which light pulses can propagate both from the first end to the second end and from the second end to the first end—that is to say in both directions.

A unidirectional loop is intended in particular to mean a loop in which light pulses can propagate along the loop only in a specific direction, either from the first end to the second end or from the second end to the first end. Preferably, an isolator device, in particular an isolator, is arranged in the unidirectional loop, the isolator device being adapted to transmit light pulses only in one direction, and to block them in the other direction, for example by using the Faraday effect, or in another suitable way. The isolator device is preferably arranged in a ring part of the unidirectional loop.

The bidirectional loop is preferably a first fiber loop.

A fiber loop is this case intended to mean a loop that at least locally comprises a fiber or consists of a fiber. In a preferred configuration, the fiber loop consists entirely of a fiber or is composed of a multiplicity of fibers connected to one another.

The unidirectional loop is preferably a second fiber loop. In particular, the unidirectional loop is preferably configured as a unidirectional ring.

According to one embodiment of the invention, the first amplifying fiber is doped with at least one element selected from a group consisting of ytterbium, neodymium, erbium, thulium and holmium. In one embodiment, the first amplifying fiber is doped with precisely one of the aforementioned elements. In another embodiment, the first amplifying fiber is doped with a combination of at least two of these elements, in particular with a combination of precisely two of the aforementioned elements. In one embodiment, the first amplifying fiber is doped with erbium and ytterbium (Er/Yb). In another embodiment, the first amplifying fiber is doped with thulium and holmium (Tm/Ho). As already explained above, it is with these doping elements and the wavelengths associated therewith that the advantages mentioned are achieved.

In one embodiment, the bidirectional loop has an asymmetry. In particular, according to one embodiment, the bidirectional loop is configured asymmetrically for two light pulses that travel through the bidirectional loop in opposite directions.

According to one embodiment of the invention, the bidirectional loop comprises an asymmetry element, in particular an asymmetrically arranged amplifying element for asymmetric amplification, and/or an asymmetrically arranged attenuating element for asymmetric attenuation, of the light pulses propagating in opposite directions along the bidirectional loop. The asymmetry element is generally adapted and/or arranged to generate a difference in the respective self-phase modulation between a light pulse propagating in a particular first direction along the bidirectional loop and a light pulse propagating in the other, second direction along the bidirectional loop.

The asymmetrically arranged amplifying element is preferably variably adjustable in respect of the gain. When the first amplifying fiber is configured as the amplifying element, a variable gain may be implemented by varying the pump power.

Alternatively or in addition, the asymmetrically arranged attenuating element is preferably variably adjustable in respect of the attenuation.

In general, a variable phase shift between the two counter-running light pulses in the bidirectional loop may be implemented by means of variable adjustment of the asymmetry element; in particular, the phase shift may be adjusted by variable driving of the asymmetry element.

In particular, according to one embodiment, the first amplifying fiber may be arranged asymmetrically in the bidirectional loop. This means in particular that the first amplifying fiber is arranged closer to the first end of the bidirectional loop than to the second end, or vice versa. Alternatively, according to another embodiment an asymmetrically arranged attenuating element, in particular an asymmetrically arranged output coupling element, for example a tap coupler, or a filter, a polarization attenuator or the like, may be arranged in the bidirectional loop. The aforementioned embodiments may also be combined with one another.

In particular, the bidirectional loop is preferably configured as a nonlinear amplifying loop mirror (NALM). In this case, the bidirectional loop has an asymmetry so that different light pulses, which travel through the bidirectional loop in different directions, travel through a relatively long part of the bidirectional loop with a different intensity level depending on their circulation direction, since—in relation to the distance of the bidirectional loop—they are amplified and/or attenuated earlier or later. Because of the self-phase modulation in the bidirectional loop, this leads to a phase shift between two light pulses that travel opposite to one another through the bidirectional loop, this phase shift itself in turn being intensity-dependent.

The phase shift between the two light pulses in turn influences their coupling behavior at the 3×3 coupler. In this way, light pulses are fed only above a particular intensity threshold effectively in the appropriate propagation direction via the 3×3 coupler out of the bidirectional loop into the unidirectional loop, so that in particular the bidirectional loop configured as an NALM can fulfill the function of a saturable absorber.

The loop arrangement consisting of the bidirectional loop and the unidirectional loop, which are coupled to one another via the 3×3 coupler, and therefore also the fiber oscillator overall, preferably have a so-called figure-of-eight configuration.

The 3×3 coupler preferably comprises a multiplicity of ports, in particular six ports. The 3×3 coupler is preferably configured symmetrically, which means in particular that light pulses are split into equal parts over the various ports of the 3×3 coupler. A port is in this case intended to mean a connection of the 3×3 coupler, which can act as an input or as an output and, in particular, can be connected so as to conduct light to the fiber.

The 3×3 coupler preferably comprises three ports on a first side, namely a first port, a second port and a third port. On a second side, the 3×3 coupler comprises three further ports, namely a fourth port, a fifth port and a sixth port. The first port is directly connected via a fiber section so as to conduct light to the fourth port. The second port is directly connected via a fiber section so as to conduct light to the fifth port. The third port is directly connected via a fiber section so as to conduct light to the sixth port. Light pulses that propagate between two ports directly connected to one another do not experience a phase jump. The 3×3 coupler is, however, adapted so that light pulses can crosstalk between the direct connections of the ports, but in which case they experience a phase shift that is preferably—regardless of the two connections between which a light pulse crosstalks −2π/3.

In one embodiment of the fiber oscillator, the 3×3 coupler is generally adapted to impart a phase shift of 2π/3 to light pulses that crosstalk between two different direct connections of the ports of the 3×3 coupler. This makes it possible, in particular, to impart a corresponding phase shift to the two counter-running light pulses in the NALM.

A particular embodiment of the 3×3 coupler will be described below by considering a particular possible arrangement and interconnection of ports of the 3×3 coupler. A person skilled in the art will readily understand that there are numerous other embodiments that are equivalent, almost equivalent or at least have the same function as the arrangement described, but which fulfill the same purpose.

In particular, a first end of the unidirectional loop is connected so as to conduct light to the third port. A second end of the unidirectional loop is connected so as to conduct light to the third port. The unidirectional loop is adapted—in particular by the isolator device—so that a light pulse can travel along the unidirectional loop only from the third port to the first port, but not in the opposite direction.

A first end of the bidirectional loop is connected so as to conduct light to the fifth port. A second end of the bidirectional loop is connected so as to conduct light to the sixth port. The second port and the fourth port may preferably be used to couple light pulses out of the fiber oscillator, whether as useful light or for monitoring.

A light pulse entering the 3×3 coupler via the first port from the unidirectional loop is split there into three light pulses of equal pulse energy onto the fourth port, the fifth port and the sixth port. The light pulses at the fifth port and at the sixth port respectively experience a phase shift of 2π/3 in relation to the light pulse entering at the first port. The light pulse at the fifth port will be referred to below as a first light pulse, and the light pulse at the sixth port as a second light pulse. The first light pulse then travels through the bidirectional loop starting from the first end to the second end—namely from the fifth port to the sixth port, the second light pulse traveling through the bidirectional loop in the opposite direction—namely from the sixth port to the fifth port.

Because of the asymmetric configuration of the bidirectional loop, the first light pulse and the second light pulse then experience different phase shifts, or B integrals, during their propagation along the bidirectional loop. The difference in the B integrals, or the phase shift between the first light pulse and the second light pulse, depends in particular on the original intensity of the light pulses—before travelling through the bidirectional loop—and the gain and/or attenuation in the first amplifying fiber, that is to say in particular on a pump level of the first amplifying fiber. The attenuation may optionally also be configured variably in order to influence the phase shift.

Arriving at the fifth port, the second light pulse then crosstalks partially across the direct optical connection between the sixth port and the third port, while again experiencing a phase shift of 2π/3. The first light pulse arriving at the sixth port is forwarded directly to the third port, without experiencing a phase shift. An output pulse resulting at the third port from superposition of the first light pulse and the second light pulse therefore depends, in particular, on the B integrals that the light pulses experience during their propagation along the bidirectional loop.

In this case, the 3×3 coupler is adapted so that even with a vanishing nonlinear phase shift between the first light pulse and the second light pulse, a finite transmission of preferably about 10% of the input pulse energy and a nonvanishing gradient of the phase-dependent transmission profile result, which significantly simplifies laser pulse synthesis from the noise. In particular, it facilitates the start, in particular a self-start, of mode-coupled operation. With an increasing phase shift, the transmission rises to a maximum of preferably about 45%—without taking the amplification by the first amplifying fiber into account—with a maximum phase shift of 2π/3. The bidirectional loop therefore favors light pulses with a relatively high peak power and can therefore fulfill the function of a saturable absorber.

By varying the pump power for the first amplifying fiber in the bidirectional loop, the nonlinear phase shift between the first light pulse and the second light pulse can be variably adjusted.

The first amplifying fiber is preferably doped with at least one element that is selected from a group consisting of: ytterbium, neodymium, erbium, holmium and thulium. The doping element, or optionally the combination of doping elements, in this case determines in particular an optical wavelength for the fiber oscillator: if the first amplifying fiber comprises ytterbium or neodymium as a doping element, the wavelength lies approximately at from 900 nm to 1100 nm; the fiber oscillator is then preferably used for the processing of transparent materials or for telecommunications. If the first amplifying fiber contains erbium as a doping element, the wavelength lies approximately at 1500 nm; the fiber oscillator is then preferably used, e.g., in telecommunications applications or in the medical sector. If the first amplifying fiber comprises thulium or holmium as a doping element, the wavelength lies approximately at from 1900 nm to 2100 nm; the fiber oscillator is then preferably used in semiconductor technology or in the field of medical technology.

That the fiber oscillator has overall a normal dispersion or that—expressed differently but meaning the same thing—an overall dispersion of the fiber oscillator lies in the normal dispersion range, means in particular that a light pulse travelling through the fiber oscillator has experienced a normal dispersion after travelling through the fiber oscillator—that is to say each component of the fiber oscillator has been passed through once. This in turn means that, in comparison with a temporal shape of the light pulse before travelling through the fiber oscillator, higher frequencies lag in the temporal shape of the light pulse after travelling through the fiber oscillator while lower frequencies lead. Higher frequencies thus run through the fiber oscillator more slowly than lower frequencies. This does not necessarily mean that every optical component of the fiber oscillator has a normal dispersion; rather, the effect arises at least for the sum of the optical components. Thus, while in one preferred configuration it is possible for all optical components of the fiber oscillator to have a normal dispersion, in another preferred configuration it is likewise possible for at least a first optical component of the fiber oscillator to have an anomalous dispersion, the fiber oscillator having at least one other, second optical component that has a normal dispersion that overcompensates for the anomalous dispersion of the first optical component, so that expression of the fiber oscillator is normal overall. If the fiber oscillator comprises a dispersion-compensating element, it is preferably arranged in the unidirectional loop.

If the wavelength of the fiber oscillator lies in the normal dispersion range, for example when using ytterbium or neodymium as a doping element, no further additional methods, in particular no dispersion-compensating element, are preferably needed in order to keep the overall dispersion of the fiber oscillator in the normal range. The fiber oscillator may however, according to one embodiment, also comprise at least one dispersion-compensating element in such a case, in order to move the dispersion into a desired range within the normal dispersion range, in particular for fine tuning of the dispersion. In particular, with the aid of a dispersion-compensating element the overall dispersion may be reduced in magnitude. The dispersion-compensating element may, according to one embodiment, in particular be configured as a chirped grating, in particular as a chirped fiber Bragg grating.

If the wavelength of the fiber oscillator lies in the anomalous dispersion range, on the other hand, for example when using erbium, thulium or holmium as a doping element, the fiber oscillator preferably comprises at least one dispersion-compensating element in order to bring the overall dispersion into the normal range. The at least one dispersion-compensating element is preferably configured as a dispersion-compensating fiber or as a chirped grating, in particular as a chirped fiber Bragg grating. Preferably, the dispersion-compensating element is arranged in the unidirectional loop. A dispersion-compensating fiber will also be referred to as a dispersion-compensated fiber or dispersion-adapted fiber. Such a dispersion-compensating fiber may, for example, have a fiber core that comprises rings with different refractive indices.

According to one embodiment of the invention, the unidirectional loop does not comprise any amplifying medium. In this case, the first amplifying fiber is advantageously the only amplifying medium of the fiber oscillator, in particular the only amplifying fiber. The fiber oscillator may therefore have a very simple and economical structure.

According to an alternative preferred configuration, the unidirectional loop may comprise an—additional—amplifying medium, in particular a second amplifying fiber, an isolator element—in a preferred configuration the isolator device of the unidirectional loop, which is provided anyway—being arranged in the propagation direction of a light pulse—preferably in the unidirectional loop—between the amplifying element and the first amplifying fiber. In addition or alternatively, an isolator element is preferably arranged in the propagation direction of the light pulse between the first amplifying fiber and the amplifying element. With the aid of the amplifying element, losses may in particular advantageously be compensated for by amplification of light pulses in the fiber oscillator taking place not only in the first amplifying fiber but also in the additional amplifying medium. At the same time, this allows greater freedom in the selection of the gain for the first amplifying fiber and therefore freer adaptation of the phase shift between the first light pulse and the second light pulse, since a variation of the overall gain of the fiber oscillator in the event of a variation of the gain in the first amplifying fiber may correspondingly be compensated for by means of the additional amplifying medium. The isolator element may, in a preferred configuration, be configured as an isolator or as a circulator.

The second amplifying fiber is preferably doped with the same element as the first amplifying fiber.

Preferably, the bidirectional loop comprises an input coupling device, which is adapted to couple pump light into the first amplifying fiber. The input coupling device arranged in the bidirectional loop may at the same time also be used to couple pump light into the additional amplifying medium, e.g., into the second amplifying fiber. Furthermore, the preferably asymmetrically arranged input coupling device may be used as an asymmetry element, in particular as an asymmetrically arranged attenuating element.

Alternatively, it is preferably possible for an input coupling element, which is adapted to couple pump light into the additional amplifying medium, e.g., the second amplifying fiber, to be arranged in the unidirectional loop. Preferably, the input coupling device is at the same time also used to couple pump light into the first amplifying fiber.

Alternatively, it is preferably also possible for the bidirectional loop to comprise a first input coupling device for coupling pump light into the first amplifying fiber, the unidirectional loop comprising a second input coupling device, which is adapted to couple pump light into the additional amplifying medium.

The input coupling device, whether the first input coupling device or the second input coupling device or a single input coupling device, is preferably configured as a wavelength division multiplex (WDM) coupler.

According to one embodiment of the invention, the unidirectional loop comprises a reflecting arm, a reflector element being arranged in the reflecting arm. By means of the reflector element, according to one embodiment additional optical functions may also be implemented, in particular the function of a bandwidth-limiting element and/or of a dispersion-compensating element. The reflecting arm offers advantages with regard to the arrangement and bilateral isolation of an additional amplifying medium in the reflecting arm.

The reflecting arm preferably comprises at least one fiber or preferably consists of at least one fiber.

The reflector element is preferably arranged at a reflection end of the reflecting arm. The reflecting arm is preferably configured as a linear branch of the unidirectional loop, which is connected so as to conduct light to a ring part of the unidirectional loop. The reflecting arm, in particular the linear branch, comprises the reflector element at the reflection end and is connected at a terminal end, lying opposite the reflection end, so as to conduct light to the ring part. A light pulse travelling through the unidirectional loop travels through the reflecting arm two times, once from the terminal end to the reflection end and then back from the reflection end to the terminal end.

The reflector element is preferably configured to be semitransparent—or expressed the other way round semireflective—so that a predetermined fraction of light is coupled out via the reflector element from the fiber oscillator.

According to one embodiment of the fiber oscillator, the reflector element is configured as a wavelength fixing element, that is to say in particular as an element that is adapted to establish a central wavelength for the fiber oscillator. The reflector element therefore advantageously allows unique establishment of the central wavelength with which the fiber oscillator is operated. This offers the great advantage of a high reproducibility together with increased variability in order to obtain a particular desired wavelength as the central wavelength. This may in particular be crucial in subsequent processes whose efficiency depends on the wavelength, for example in material processing operations, in an amplification chain, and/or in frequency conversion.

According to one embodiment of the invention, the reflector element is configured as a fiber Bragg grating. The fiber Bragg grating may preferably function as a dispersion-compensating element, as a wavelength-fixing element and/or as a bandwidth-limiting element. In order to be able to function as a dispersion-compensating element, the fiber Bragg grating is preferably configured as a chirped fiber Bragg grating. The fiber-Bragg grating may also act as a wavelength-fixing element or as a bandwidth-limiting element if it is configured as unchirped fiber Bragg grating.

According to one embodiment of the invention, the fiber oscillator comprises a dispersion-compensating element. The dispersion-compensating element is preferably formed by the reflector element, by the reflector element being configured as a chirped fiber Bragg grating. Alternatively or in addition, the dispersion-compensating element is a dispersion-compensating fiber, which is preferably arranged in the unidirectional loop. Alternatively or in addition, the first amplifying fiber is configured to be dispersion-compensated.

According to one embodiment of the invention, the reflecting arm is connected so as to conduct light via a circulator element to a ring part of the unidirectional loop. The circulator element is in this case preferably used at the same time as an isolator device of the unidirectional loop. The ring part comprises a ring branch, which is connected so as to conduct light at a first ring branch end to the 3×3 coupler—in particular to the third port—and at a second ring branch end to the reflecting arm. The ring part furthermore comprises a second ring branch, which is connected so as to conduct light at a first ring branch end to the reflecting arm and at a second ring branch end to the 3×3 coupler—in particular to the first port. A light pulse entering via the third port of the 3×3 coupler into the first ring branch travels through the latter to the circulator element, is coupled by the letter into the terminal end of the reflecting arm, travels through the reflecting arm to the reflector element arranged at the reflection end, is at least partially reflected there, travels along the reflecting arm back to the terminal end, is coupled there by the circulator element into the second ring branch, and travels through the latter to the first port of the 3×3 coupler. The light pulse therefore respectively travels once through the first ring branch and the second ring branch, while it travels two times—forward and back—through the reflecting arm.

According to one embodiment of the invention, a second amplifying fiber is arranged, in particular as the additional amplifying medium already mentioned above, in the unidirectional loop. Preferably, the second amplifying fiber is arranged in the reflecting arm. This is found to be advantageous since in this way a light pulse propagating in the unidirectional loop passes through the second amplifying fiber two times, so that the light pulse is doubly amplified. Furthermore, the second amplifying fiber is advantageously separated by the circulator element—e.g., in both directions—from the first amplifying fiber, so that the two amplifying fibers do not disadvantageously influence one another.

The second amplifying fiber is preferably doped with the same element as the first amplifying fiber.

The fiber oscillator preferably comprises, outside the unidirectional loop, in particular outside the loop arrangement—in the propagation direction of a light pulse coupled out by the reflector element—behind the first reflector element, a coupling device for coupling pump light into the fiber oscillator, e.g., into the unidirectional loop. In this way, pump light may advantageously be coupled via the reflector element into the unidirectional loop. The coupling device may, however, also be arranged inside the unidirectional loop, e.g., in the reflecting arm.

According to one embodiment of the invention, the fiber oscillator comprises a bandwidth-limiting element. Preferably, the bandwidth-limiting element is arranged in the unidirectional loop. By the interaction of normal dispersion and self-phase modulation, strongly chirped light pulses, which are spectrally and temporally broadened during their propagation, are generated in the fiber oscillator. The bandwidth-limiting element advantageously clips fractions on both sides of the spectrum and therefore—because of the strong chirp—shortens the light pulses not only spectrally but also temporally. In particular, in this way the boundary condition of the periodicity for a light pulse circulating in the fiber oscillator may be fulfilled.

The bandwidth-limiting element preferably has a bandwidth of from at least 1 pm to at most 20 nm, preferably from at least 10 pm to at most 15 nm.

According to one embodiment of the invention, the bandwidth-limiting element is configured as a bandpass filter. This represents a suitable configuration of the bandwidth-limiting element.

Alternatively or in addition, provision is preferably made that the reflector element, in particular the fiber Bragg grating, is configured as a bandwidth-limiting element. This is advantageous since it then does not require any additional components for the bandwidth limitation. In this case, the fiber Bragg grating may be configured as unchirped fiber Bragg grating, or alternatively as a chirped fiber Bragg grating.

The fiber Bragg grating may additionally or as an alternative also function as a dispersion-compensating element, in particular when it is configured as a chirped fiber Bragg grating.

Alternatively or in addition, a dispersion-compensating fiber is preferably arranged as a dispersion-compensating element in the unidirectional loop.

According to one embodiment of the invention, an additional amplifying fiber, which is referred to here for terminological distinction as a third amplifying fiber regardless of whether a second amplifying fiber is additionally present, is arranged in the unidirectional loop. This configuration is in particular preferred in an exemplary embodiment of the fiber oscillator in which the unidirectional loop consists of a ring part, the unidirectional loop in particular not comprising a linear branch, in particular not comprising a reflecting arm. The third amplifying fiber is therefore arranged in particular in the ring part of the unidirectional loop. Losses of the fiber oscillator may advantageously be compensated for with the third amplifying fiber.

According to another preferred exemplary embodiment, however, the third amplifying fiber is provided in addition to a second amplifying fiber provided in the reflecting arm, the third amplifying fiber preferably also being arranged in the ring part of the unidirectional loop in this case.

The third amplifying fiber is preferably doped with the same element as the first amplifying fiber—and preferably as the second amplifying fiber.

Preferably, the fiber oscillator comprises an output coupling device for output coupling of light pulses in the unidirectional loop. In this way, it is possible to couple light pulses out—whether as useful light or to check the fiber oscillator—not only via the second port or the fourth port of the 3×3 coupler but additionally or as an alternative via the output coupling device. Because of the interaction of dispersion on the one hand and self-phase modulation on the other hand along the fiber oscillator, the light pulses that are coupled out have different temporal widths as a function of the position where they are coupled out. Thus, in particular, light pulses having different temporal widths may be coupled out from the second port of the 3×3 coupler, the fourth port of the 3×3 coupler and via the output coupling device.

The output coupling device is preferably configured as a tap coupler.

The bandwidth-limiting element, in particular the reflector element or the bandpass filter, is preferably configured to be variable in respect of its bandwidth, preferably as a temperature-dependent grating, or as a grating that is sensitive to extension or compression in respect of its bandwidth.

According to one embodiment of the invention, all optical components of the fiber oscillator are configured so as to preserve polarization. This is found to be a advantageous configuration for the fiber oscillator.

According to one embodiment of the invention, the overall—normal—dispersion or—normal—overall dispersion of the fiber oscillator is reduced, in particular close to zero, in order to obtain pulses that are as short as possible. The terms “overall dispersion” and “total dispersion” are in this case in particular used synonymously. In one preferred configuration, the overall dispersion of the fiber oscillator is reduced, in particular adjusted to a predetermined value, by suitable tuning of the individual optical components to one another, preferably by arranging at least one dispersion-compensating element in the fiber oscillator.

According to one embodiment of the invention, all optical components of the fiber oscillator are formed by fibers or consist of fibers, and in particular are fiber-based components or fiber-coupled components. In particular, the fiber oscillator preferably has no free-beam components. In this case, there is no adjustment outlay in connection with the fiber oscillator.

According to another embodiment, however, it is also possible for the fiber oscillator to comprise at least one optical component that is configured as a free-beam component.

Preferably, the fiber oscillator has a pulse repetition rate from 1 MHz to 150 MHz.

Embodiments of the present invention also provide a laser device that has a pump light source and a fiber oscillator according to according to one or more of the exemplary embodiments described above. The pump light source and the fiber oscillator are connected to one another so as to conduct light, so that pump light of the pump light source can be coupled into the fiber oscillator. In connection with the laser device, in particular the advantages that have already been explained in connection with the fiber oscillator are achieved.

In particular, the pump light source is connected so as to conduct light to the first amplifying fiber, so that pump light of the pump light source may be used to pump the first amplifying fiber.

According to one embodiment of the invention, the laser device comprises a control device.

The control device is preferably actively connected to a variably drivable asymmetry element of the bidirectional loop in order to adjust the variable asymmetry element, e.g., in order to adjust the nonlinear phase shift between the light pulses travelling in an opposite direction through the bidirectional loop, e.g., in such a way that the phase shift is at most 2π/3, preferably 2π/3.

In particular, the control device is preferably actively connected to a variably drivable amplifying element in order to adjust the variably drivable amplifying element in respect of its gain.

In one embodiment, the control device is actively connected to the pump light source and is adapted to adjust a pulse duration of the fiber oscillator by selecting the pump power of the pump light source. The control device is preferably adapted to select the pump power of the pump light source so that the nonlinear phase shift between the light pulses travelling in an opposite direction through the bidirectional loop is at most 2π/3, preferably 2π/3.

Alternatively or in addition, the control device is preferably actively connected to a variably drivable attenuating element in order to adjust the variable drivable attenuating element in respect of its attenuation, e.g., in such a way that the nonlinear phase shift between the light pulses travelling in an opposite direction through the bidirectional loop is at most 2π/3, preferably 2π/3. Preferably, a larger pulse duration range may be covered in this way than—optionally only—by selecting the pump power.

Alternatively or in addition, provision is made that the control unit is actively connected to the bandwidth-limiting element, which is configured to be variable in respect of its bandwidth, in particular to the reflector element or the bandpass filter, optionally in conjunction with a further optical element, in particular a further bandwidth-limiting element and is adapted to adjust a bandwidth of the bandwidth-limiting element. In this way, the fiber oscillator is configured to be flexible in respect of bandwidth and in particular pulse duration.

Preferably, in addition to the variable bandwidth-limiting element, the fiber oscillator also comprises a further filter element, in which case an overlap range between the bandwidth-limiting element and the filter element may be adjusted by varying the bandwidth of the variable bandwidth-limiting element. In this way, an effective bandwidth of the combination of the bandwidth-limiting element and the filter element may be adjusted very efficiently.

The bandwidth-limiting element may in particular be thermally or chemically variable, for example by heating or cooling, or by extension or compression.

A variable bandwidth limitation may also be achieved with a Fabry-Pérot filter, in which a distance between two faces, which are responsible for the Fabry-Pérot property, are varied.

The control device is preferably adapted to generate a first, high asymmetry in the bidirectional loop in a startup operating mode by driving the variably drivable asymmetry element, in order to favor rapid starting of the laser activity in the fiber oscillator, the control device being adapted to drive the variably drivable asymmetry element in a continuous operating mode so as to generate a second, lower asymmetry in the bidirectional loop in order to ensure stable continuous operation of the fiber oscillator. In particular, the control device is adapted to drive a variably drivable attenuating element correspondingly, in order to adjust a first, higher attenuation in the startup operating mode and to adjust a second, lower attenuation in the continuous operating mode.

Embodiments of the present invention also provide a method for operating a fiber oscillator according to one or more of the embodiments described above, the first, higher asymmetry being generated—in particular by driving a variably drivable asymmetry element—in the bidirectional loop in a startup operating mode, and a second, lower asymmetry being generated in the bidirectional loop in a continuous operating mode. In particular, in the scope of the method, preferably in the case of a variably drivable attenuating element a first, higher attenuation is adjusted in the startup operating mode, a second, lower attenuation being adjusted in the continuous operating mode.

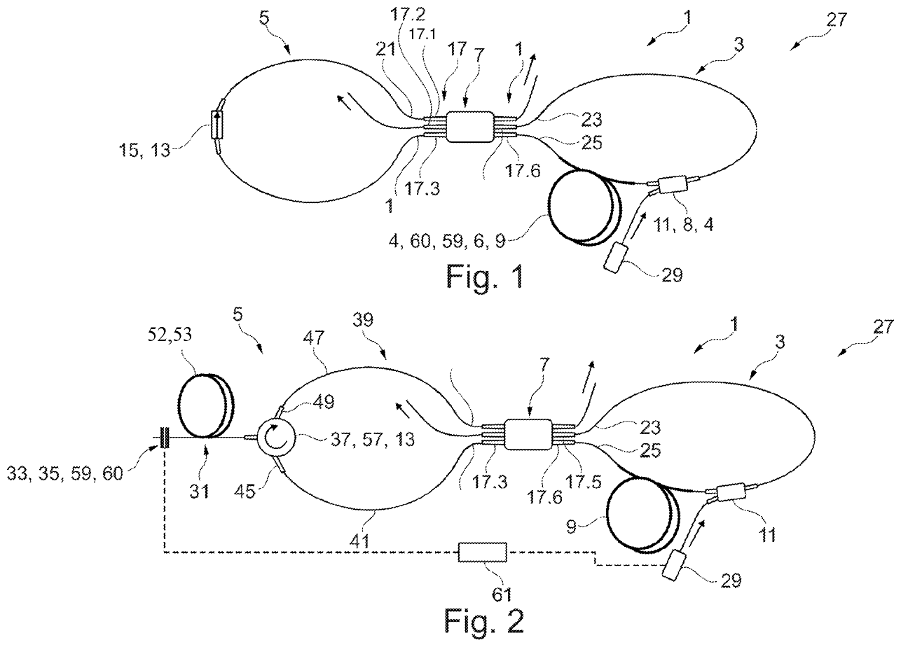

FIG. 1 shows a schematic representation of a first exemplary embodiment of a passively mode-coupled fiber oscillator 1. The fiber oscillator 1 comprises a bidirectional loop 3 and a unidirectional loop 5, the bidirectional loop 3 and the unidirectional loop 5 being coupled to one another, in particular connected so as to conduct light, by a 3×3 coupler 7. Arranged in the bidirectional loop 3, there is a first amplifying fiber 9. The fiber oscillator 1 has overall a normal dispersion. Advantageously, the bidirectional loop 3 may in this case fulfill the function of a saturable absorber, so that the fiber oscillator 1 may in particular obviate a SESAM. The problem of degradation and deadjustment associated with a SESAM is therefore also entirely avoided. In particular, no problems with degradation and/or deadjustment occur in connection with the bidirectional loop 3. By suitable selection of the first amplifying fiber 9, in particular of an element with which the first amplifying fiber 9 is doped, suitable wavelengths may be provided for the fiber oscillator 1, e.g., in the range of from about 900 nm to 1100 nm (ytterbium, neodymium) through 1500 nm (erbium) to from about 1900 nm to 2100 nm (thulium, holmium). By specific tuning of the overall dispersion of the fiber oscillator 1 in the normal range, well-defined dispersion properties are advantageously provided. In a preferred configuration, the amplifying fiber 9 is configured as a bandwidth-limiting element 59 and/or as a dispersion-compensating element 60. In particular, the amplifying fiber 9 may fulfill the function of bandwidth limitation on the basis of its gain bandwidth.

Advantageously, the—normal—overall dispersion of the fiber oscillator 1 is reduced, in particular close to zero or equal to zero.

The first amplifying fiber 9 is preferably doped with at least one element that is selected from a group consisting of: ytterbium, neodymium, erbium, holmium and thulium. The first amplifying fiber 9 may also be doped with a combination of at least two of the aforementioned elements, in particular with a combination of precisely 2 of these elements.

Preferably, the bidirectional loop 3 has an asymmetry for two light pulses that travel through the bidirectional loop 3 in opposite directions, e.g., in the form of an asymmetry element 4. This asymmetry may, in particular, be implemented by an asymmetrically arranged amplifying element 6 and/or an asymmetrically arranged attenuating element 8 in the bidirectional loop 3. In the exemplary embodiment represented here, the first amplifying fiber 9 is arranged asymmetrically as an amplifying element 6 in the bidirectional loop 3. In particular, the bidirectional loop 3 is configured as a nonlinear amplifying loop mirror (NALM).

Preferably, an input coupling device 11 for coupling pump light in is arranged in the bidirectional loop 3. The input coupling device 11 is preferably configured as a wavelength division multiplex (WDM) coupler. The input coupling device 11 may also act as an attenuating element 8 here. As an attenuating element 8, a tap coupler may for example also be arranged in the bidirectional loop 3.

An isolator device 13, in particular an isolator 15, is preferably arranged in the unidirectional loop 5.

The 3×3 coupler 7 is preferably configured to impart a phase shift of 2π/3 to light pulses that crosstalk between different direct connections of a multiplicity of ports 17 of the 3×3 coupler 7. In particular, a corresponding phase shift is then imparted to counter-running light pulses in the NALM.

A particular embodiment of the 3×3 coupler 7 will be described below with the aid of FIG. 1 by considering a particular possible arrangement and interconnection of ports 17 of the 3×3 coupler 7. Numerous other embodiments that are equivalent, almost equivalent or at least have the same function as the arrangement described, but which fulfill the same purpose, are possible.

According to the exemplary embodiment represented here, the 3×3 coupler 7 comprises in particular a first port 17.1, a second port 17.2, a third port 17.3, a fourth port 17.4, a fifth port 17.5 and a sixth port 17.6. A first end 19 of the unidirectional loop 5 is connected so as to conduct light to the third port 17.3. A second end 21 of the unidirectional loop 5 is connected so as to conduct light to the first port 17.1. By the configuration and arrangement of the isolator device 13, light pulses can propagate along the unidirectional loop 5 only from the third port 17.3 to the first port 17.1. A first end 23 of the bidirectional loop 3 is connected so as to conduct light to the fifth port 17.5. A second end 25 of the bidirectional loop 3 is connected so as to conduct light to the sixth port 17.6. The second port 17.2 and the fourth port 17.4 are preferably used to couple light pulses out of the fiber oscillator 1, whether as useful light or for monitoring.

A light pulse entering the 3×3 coupler 7 via the first port 17.1 from the unidirectional loop 5 is split by the 3×3 coupler 7 into three light pulses of equal pulse energy onto the fourth port 17.4, the fifth port 17.5 and the sixth port 17.6. The light pulses at the fifth port 17.5 and at the sixth port 17.6 respectively experience a phase shift of 2π/3 in relation to the light pulse entering at the first port 17.1. The light pulse at the fifth port 17.5 will be referred to below as a first light pulse, and the light pulse at the sixth port 17.6 as a second light pulse. The first light pulse then travels through the bidirectional loop 3 starting from the first end 23 to the second end 25, the second light pulse traveling through the bidirectional loop 3 in the opposite direction.

Because of the first amplifying fiber 9 arranged asymmetrically in the bidirectional loop 3, the first light pulse and the second light pulse then experience different phase shifts, or B integrals, during their propagation along the bidirectional loop 3. The difference in the B integrals, or the phase shift between the first light pulse and the second light pulse, depends in particular on the original intensity of the light pulses—before travelling through the bidirectional loop 3—and the gain in the first amplifying fiber 9, that is to say in particular on a pump level of the first amplifying fiber 9.

Arriving at the fifth port 17.5, the second light pulse then crosstalks partially across a direct optical connection between the sixth port 17.6 and the third port 17.3, while again experiencing a phase shift of 2π/3. The first light pulse arriving at the sixth port 17.6 is forwarded directly to the third port 17.3, without experiencing a phase shift. An output pulse resulting at the third port 17.3 from superposition of the first light pulse and the second light pulse therefore depends, in particular, on the B integrals that the light pulses experience during their propagation along the bidirectional loop 3.

Light fractions that travel back into the first port 17.1 are eliminated by the isolator device 13. Only light pulses that enter the unidirectional loop 5 via the third port 17.3 are transmitted. The bidirectional loop 3 functions as a saturable absorber.

In the first exemplary embodiment of the fiber oscillator 1, the unidirectional loop 5 does not comprise any amplifying medium. In particular, the first amplifying fiber 9 is the only amplifying medium here, in particular the only amplifying fiber of the fiber oscillator 1.

FIG. 1 shows at the same time an exemplary embodiment of a laser device 27 that comprises a pump light source 29 and the fiber oscillator 1, the pump light source 29 being connected so as to conduct light to the fiber oscillator 1, in particular to the input coupling device 11, so that pump light of the pump light source 29 can be coupled into the fiber oscillator 1.

FIG. 2 shows a schematic representation of a second exemplary embodiment of the fiber oscillator 1.

Elements that are the same or functionally equivalent are provided with the same references in all the figures, so that in this regard reference is respectively made to the preceding description.

In this exemplary embodiment, the unidirectional loop 5 comprises a reflecting arm 31 in which, in the second exemplary embodiment represented here, a reflector element 35 configured as a fiber Bragg grating 33 is arranged. The reflecting arm 31 is connected so as to conduct light via a circulator element 37 to a ring part 39 of the unidirectional loop 5. In particular, the ring part 39 comprises a first ring branch 41, which is connected by a first ring branch end 43 to the third port 17.3 of the 3×3 coupler 7, it being connected by a second ring branch end 45 to the circulator element 37. The ring part 39 furthermore comprises a second ring branch 47, which is connected by a first ring branch end 49 to the circulator element 37 and by a second ring branch end 51 to the first port 17.1 of the 3×3 coupler 7. The circulator element 37 acts here as an isolator device 13. A light pulse travelling through the unidirectional loop 5 starting from the third port 17.3 to the second port 17.1 respectively travels through the ring branches 41, 47 once, but through the reflecting arm 31 two times, namely once to the reflector element 35 and once back from the reflector element 35.

Arranged as an amplifying medium 52 in the reflecting arm 31, there is a second amplifying fiber 53, which is preferably doped with the same element as that with which the first amplifying fiber 9 is doped. The amplifying medium 52, in particular the second amplifying fiber 53, may however also be arranged at a different position in the fiber oscillator 1.

The reflector element 35 is preferably configured to be semitransmissive or semireflective, wherein on the one hand a predetermined fraction of light can be coupled out of the fiber oscillator 1 via the reflector element 35, and on the other hand pump light for the second amplifying fiber 53 can preferably be coupled into the unidirectional loop 5 via the reflector element 35.

The circulator element 37 acts, in particular, as an isolator element 57 in the unidirectional loop 5.

The reflector element 35 is preferably configured as a bandwidth-limiting element 59; in particular, the fiber Bragg grating 33—unchirped according to one configuration—is preferably configured as a bandwidth-limiting element 59. In a preferred embodiment, it is possible for the bandwidth-limiting element 59 to be configured to be variable—in particular thermally or mechanically—in respect of its bandwidth.

The bandwidth-limiting element 59 preferably has a bandwidth of from at least 1 pm to at most 20 nm, preferably from at least 10 pm to at most 15 nm.

When the fiber Bragg grating 33 is configured as a chirped fiber Bragg grating 33, alternatively or additionally, it can function as a dispersion-compensating element 60.

FIG. 2 furthermore shows a second exemplary embodiment of the laser device 27, which in a preferred configuration comprises a control device 61, the control device 61 being actively connected to the pump light source 29 and being adapted to adjust a pulse duration of the fiber oscillator 1 by selecting the pump power of the pump light source 29.

The control device 61 is alternatively or in addition configured actively connected to the bandwidth-limiting element 59, which is preferably configured to be variable—in particular thermally or mechanically—in in respect of its bandwidth, and is adapted to adjust a bandwidth of the bandwidth-limiting element 59, in order preferably to be able to cover a larger pulse duration range than—optionally only—by selecting the pump power.

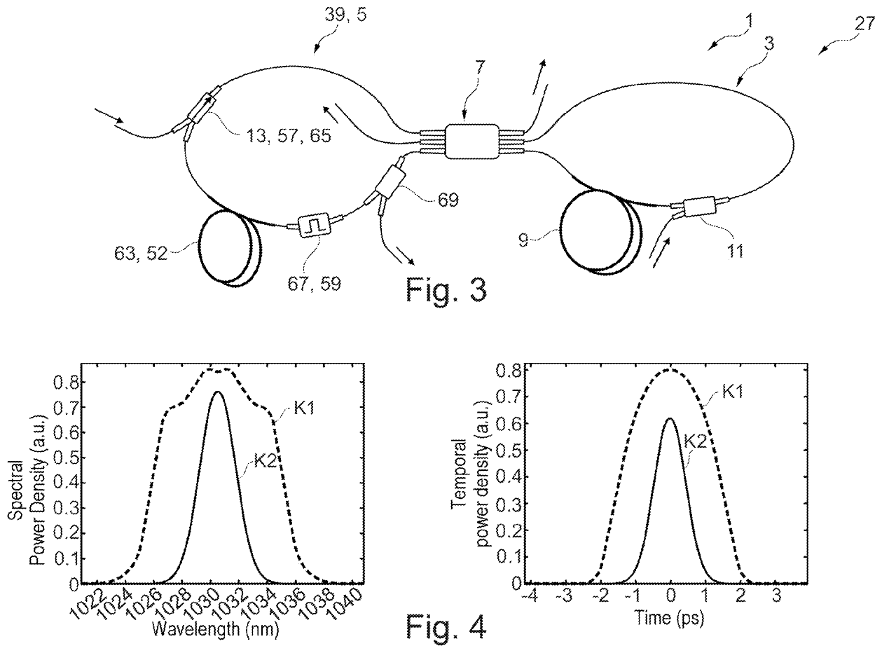

FIG. 3 shows a schematic representation of a third exemplary embodiment of the fiber oscillator 1.

In this third exemplary embodiment, the unidirectional loop 5 consists of the ring part 39—it correspondingly does not comprise a reflecting arm 31—and comprises the amplifying medium 52, here a third amplifying fiber 63 in the ring part 39, the third amplifying fiber 63 preferably being doped with the same element as the first amplifying fiber 9. The isolator device 13 is arranged as the isolator element 57 in the propagation direction behind the third amplifying fiber 63.

The isolator device 13 is here configured at the same time as a second input coupling device 65—in addition to the input coupling device 11, which to this extent is a first input coupling device—for input coupling of pump light for the third amplifying fiber 63, in particular as a wavelength division multiplex coupler.

In addition, a—preferably adjustable—bandpass filter 67 is optionally arranged as the bandwidth-limiting element 59 in the unidirectional loop 5 in the propagation direction before the third amplifying fiber 63.

Furthermore, an output coupling device 69, which is preferably configured as a tap coupler, is optionally arranged in the unidirectional loop 5. Via the output coupling device 69, in particular, useful light or light for monitoring the fiber oscillator 1 may optionally be coupled out.

FIG. 4 shows a diagrammatic explanation of the functionality of the bandwidth-limiting element 59. In this case, a plot of a spectral power density of a light pulse against the wavelength is represented at a); a plot of a temporal power density of a light pulse against time is represented at b). A first, dashed curve K1 in the plots according to a) and b) respectively shows a spectral or temporal shape of the light pulse before travelling through the bandwidth-limiting element 59, and a second, solid curve K2 respectively shows the corresponding shape of the light pulse after travelling through the bandwidth-limiting element 59.

By the interaction of normal dispersion and self-phase modulation, strongly chirped light pulses, which are spectrally and temporally broadened during their propagation, are generated in the fiber oscillator 1. The bandwidth-limiting element 59 advantageously clips fractions on both sides of the spectrum and therefore—because of the strong chirp—shortens the light pulses not only spectrally but also temporally. In particular, in this way the boundary condition of the periodicity for a light pulse circulating in the fiber oscillator 1 may be fulfilled.

In particular, spectrally broader or narrower light pulses are obtained, depending on the—preferably in particular thermally or mechanically adjustable—bandwidth of the bandwidth-limiting element 59. As a function of this, temporally shorter or longer light pulses may be generated by means of the fiber oscillator 1.

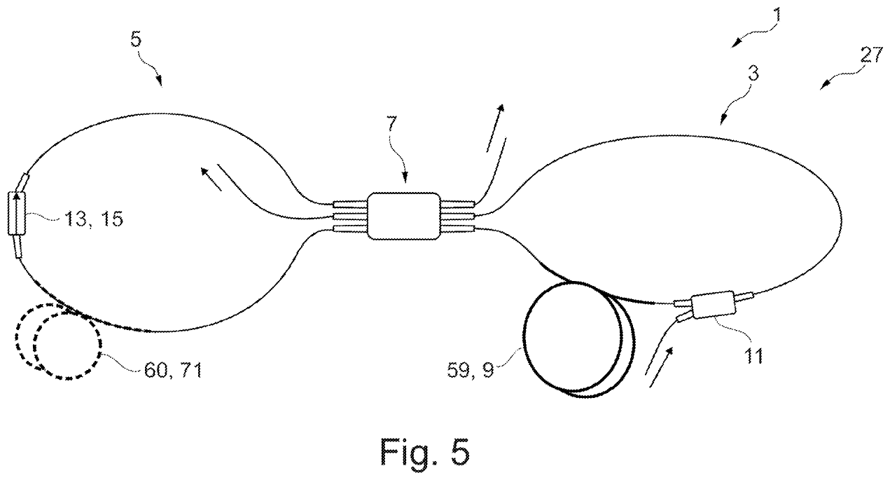

FIG. 5 shows a schematic representation of a fourth exemplary embodiment of the fiber oscillator 1. In this fourth exemplary embodiment, a dispersion-compensating fiber 71 is arranged as a dispersion-compensating element 60 in the unidirectional loop 5.

In particular with the aid of the dispersion-compensating element 60 regardless of its configuration—in particular according to FIG. 2 or FIG. 5—it is possible to adjust the—normal—overall dispersion of the fiber oscillator 1 so that it is reduced, in particular is close to zero.

Preferably, a bandwidth-limiting element 59 is also provided in this exemplary embodiment. In particular, the first amplifying fiber 9 may be configured as a bandwidth-limiting element 59. Alternatively or in addition, for example, a bandpass filter may also be provided as bandwidth-limiting element 59.

Regardless of the specific configuration of the fiber oscillator 1—in particular according to one of the exemplary embodiments described above—preferably all optical components of the fiber oscillator 1 are configured so as to preserve polarization.

Preferably, all optical components of the fiber oscillator 1 are fiber components or fiber-based components, or fiber-coupled components. In particular, the fiber oscillator 1 preferably does not comprise any free-beam component.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A passively mode-coupled fiber oscillator, comprising
a bidirectional loop,
a unidirectional loop, and
a 3×3 coupler, wherein the bidirectional loop and the unidirectional loop are coupled to each other via the 3×3 coupler,
wherein the bidirectional loop comprises a first amplifying fiber, and wherein
the fiber oscillator has overall a normal dispersion.

2. The fiber oscillator as claimed in claim 1, wherein the first amplifying fiber is doped with at least one element selected from a group consisting of ytterbium, neodymium, erbium, thulium, holmium, and a combination thereof.

3. The fiber oscillator as claimed in claim 1, wherein the first amplifying fiber is doped with Er and Yb, or with Tm and Ho.

4. The fiber oscillator as claimed in claim 1, wherein the bidirectional loop comprises an asymmetrically arranged amplifying element and/or an asymmetrically arranged attenuating element.

5. The fiber oscillator as claimed in claim 1, wherein
the unidirectional loop does not comprise an amplifying medium.

6. The fiber oscillator as claimed in claim 1, wherein the unidirectional loop comprises an amplifying medium, the fiber oscillator further comprising an isolator element arranged between the amplifying medium and the first amplifying fiber.

7. The fiber oscillator as claimed in claim 1, wherein the unidirectional loop comprises a reflecting branch, the reflecting branch comprising a reflector element.

8. The fiber oscillator as claimed in claim 7, wherein the reflector element is configured as a fiber Bragg grating.

9. The fiber oscillator as claimed in claim 7, wherein the reflector element is configured as a chirped fiber Bragg grating that functions as a dispersion-compensating element.

10. The fiber oscillator as claimed in claim 1, further comprising a dispersion-compensating fiber arranged in the unidirectional loop.

11. The fiber oscillator as claimed in claim 7, wherein the reflecting branch is connected to a ring part of the unidirectional loop via a circulator element.

12. The fiber oscillator as claimed in claim 7, wherein the unidirectional loop comprises a second amplifying fiber arranged in the reflecting branch.

13. The fiber oscillator as claimed in claim 1, further comprising a bandwidth-limiting element having a bandwidth of from at least 1 pm to at most 20 nm.

14. The fiber oscillator as claimed in claim 13, wherein the bandwidth-limiting element is configured as a bandpass filter.

15. The fiber oscillator as claimed in claim 8, wherein the first Bragg grating is configured as a bandwidth-limiting element.

16. The fiber oscillator as claimed in claim 1, wherein the unidirectional loop further comprises a second amplifying fiber, the second amplifying fiber is doped with a same element as the first amplifying fiber.

17. The fiber oscillator as claimed in claim 1, wherein all optical components of the fiber oscillator are configured as polarization-maintaining optical components.

18. A laser device comprising a pump light source configured to produce pump light, and a fiber oscillator as claimed in claim 1, wherein the pump light source and the fiber oscillator are connected to one another so as to conduct light, so that the pump light of the pump light source is capable of being coupled into the fiber oscillator.

19. The laser device as claimed in claim 18, further comprising a control device, wherein the control device is actively connected to the pump light source and is configured to adjust a pulse duration of the fiber oscillator by selecting a pump power of the pump light source.

20. The laser device as claimed in claim 18, further comprising a control device actively connected to a bandwidth-limiting element of the fiber oscillator, wherein the bandwidth-limiting element is characterized by a bandwidth that is variable, and wherein the control device is configured to adjust the bandwidth of the bandwidth-limiting element.
